(19) United States
(12) Patent Application Publication
(10) Pub. No.: US 2013/0209648 A1
(43) Pub. Date: Aug. 15, 2013

(54) WHEAT FLOUR COMPOSITION

(71) Applicants: Chandrika Mohanan, Bangalore (IN); Suresh Kumar Nediyedath, Bangalore (IN); Akalya Shanmugam, Bangalore (IN)

(72) Inventors: Chandrika Mohanan, Bangalore (IN); Suresh Kumar Nediyedath, Bangalore (IN); Akalya Shanmugam, Bangalore (IN)

(21) Appl. No.: 13/813,967

(22) PCT Filed: Aug. 5, 2011
(86) PCT No.: PCT/EP11/63554

§ 371 Date: Apr. 29, 2013

(30) Foreign Application Priority Data
Aug. 10, 2010 (IN) 2249/MUM/2010
May 31, 2011 (IN) 1597/MUM/2011

(51) Int. Cl. A21D 2/36

(52) U.S. Cl. CPC A21D 2/362
USPC 426/560; 426/503; 426/502; 426/21; 426/549

(57) ABSTRACT

The present invention relates to a wheat flour composition, a dough composition comprising the flour composition and food products comprising the wheat flour composition. It particularly relates to wheat flour composition suitable to prepare flat breads (including Indian style bread known as chapatti), noodles and pasta. The problem of the addition of gum at higher levels, although helpful in improving colour and rheological properties of dough, suffer from a beany odour experienced during preparation of the dough and during consumption of the flat bread. The same problems have been found in noodles where gum has been added to improve rheology, such as fried noodles and pasta. Surprisingly it has been found that a wheat flour composition comprising chick pea flour and guar gum, is easily processed into a dough that is soft and can easily be processed into flat breads, noodles or pasta, and the baked product (flat bread, chapatti, noodle or pasta) that is also soft and yet has acceptable sensory properties.

### TECHNICAL FIELD

The present invention relates to a wheat flour composition, a dough composition comprising the flour composition and food products comprising the wheat flour composition. It particularly relates to wheat flour composition suitable to prepare flat breads (including Indian style bread known as chapatti), noodles and pasta.

### BACKGROUND AND PRIOR ART

Flat breads, noodles and pasta are widely used food products.

Flat unleavened bread which is popular and widely consumed in several geographies, including the Indian subcontinent. Such bread is typically made from a dough, which in turn is made by mixing water with wheat flour. Dough balls are then rolled using a rolling pin. The bread needs to have several qualities such as softness, good tearability (as the breads are usually eaten by using hands without using knife/fork etc), texture, chewability and flavour.

The bread quality depends on several factors, and one of the major factor is the starting wheat flour composition. Wheat flour composition is also important as it affects the rheological properties of dough that determine ease of kneadbility and stickiness of dough, which in turn affect the rollability of the dough balls.

Additives such as guar gum are known to be added to wheat flour compositions for making chapattis in order to improve rheological properties. Shahzadi et al (International Journal of Agriculture & Biology, Vol. 7, No. 1, 100-104, 2005) disclose wheat flour compositions comprising 10% chickpea flour and 1% guar gum.

Wheat flour compositions comprising guar gum alone at 2% to 3% by weight are also disclosed.

However, it is found that addition of gum at higher levels, although helpful in improving colour and rheological properties of dough, suffer from a beany odour experienced during preparation of the dough and during consumption of the flat bread.

The same problems have been found in noodles where gum has been added to improve rheology, such as fried noodles and pasta.

It is therefore an object of the invention to provide a wheat flour composition having an improved dough rheology, but without having a beany note in the sensory appreciation.

Surprisingly it has been found that a wheat flour composition comprising chick pea flour and guar gum, is easily processed into a dough that is soft and can easily be processed into flat breads, noodles or pasta, and the baked product (flat bread, chapatti, noodle or pasta) that is also soft and yet has acceptable sensory properties.

Present inventors have also found that the beany odour caused by gum may be overcome by addition of chick pea flour in certain proportions.

### SUMMARY OF THE INVENTION

According to a first aspect of the invention there is provided a wheat flour composition comprising
a. 40-92.5% wheat flour,
b. 1.5-4.5% guar gum, and;
c. 6-15% chick pea flour.

According to a second aspect of the invention there is provided a dough composition comprising:
a. 50-70% wheat flour composition of the first aspect, and;
b. 30-50% water.

According to a third aspect of the invention there is provided a baked good obtained by the process comprising the steps of:
a. preparing a dough of the second aspect
b. shaping the dough so-obtained in individual pieces of between 50 and 1200 gram, and;
c. baking the so-obtained individual pieces by subjecting them to a baking temperature of between 110 and 400° C.

According to a fourth aspect of the invention there is provided a noodle comprising the dough according to the invention.

According to a fifth aspect of the invention there is provided a pasta comprising the wheat flour composition according to the invention.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

### Wheat Flour

The wheat flour composition comprises 40-92.5% wheat flour. The wheat flour is preferably 70-92.5%, more preferably 75-91%, and most preferably from 80-89% of the wheat flour composition.

The wheat flour may be refined wheat flour or whole wheat flour, preferably a whole wheat flour.

Particle size of the wheat flour is such that preferably at least 60%, more preferably at least 70%, and most preferably at least 80% wheat flour passes through a sieve of 150 microns. According to a particularly preferred aspect 100% wheat flour passes through 150 microns sieve.

According to one preferred aspect the wheat flour composition further comprises additional wheat bran apart from the wheat bran contents of the wheat flour. Additional wheat bran is preferably 1-15%, more preferably 4-10% and most preferably 3-8% of the wheat flour composition.

Apart from wheat bran, other fibrous material is preferably added to the wheat flour. The total fibre content of the wheat flour is preferably 5-25%, more preferably 10-20% and most preferably 12-18% of the wheat flour composition. Total fibre content is measured according to standard method described in Indian Standards, IS:11062-1984.

### Guar Gum

The gum according to the invention is guar gum. It is particularly preferred that the vegetable gum is guar gum.

The gum is 1.5-4.5%, more preferably 1.5-4%, and most preferably from 1.8-3% of the wheat flour composition.

Guar gum is preferably obtained from the ground endosperm of guar beans. The guar seeds are preferably dehusked, milled and screened to obtain the guar gum. The guar gum is preferably in form of a free flowing, pale, off-white colored powder.

Particle size of the gum is preferably in the range 50-300 microns, more preferably 100-250 microns.

### Chick Pea Flour

The term chick pea flour, also referred herein as legume flour, as used herein means flour obtained from grinding seeds of chickpea (Cicer arietinum).

It is particularly preferred the legume is selected from mung bean or chickpea. Chickpea is the most preferred legume.

The chick pea seeds are preferably soaked, dried and dehulled before grinding. The drying may be at room temperature (5-40° C.) or at higher temperature (40-200° C.).

Particle size of the chick pea flour is preferably in the range 50-600 microns, more preferably 100-400 microns and most preferably 180 to 300 microns.

The chick pea flour is 6-15%, more preferably 7-14%, and most preferably from 7.5-12% of the wheat flour composition.

The mass ratio of chick pea flour to the vegetable gum is preferably in the range 1.5 to 10, more preferably in the range 2-9 and most preferably in the range 3-8.

### Barley Flour

The composition may further comprise barley flour. In particular in doughs comprising higher amounts of chick pea flour, the composition may become slightly sticky and more difficult to process. The presence of 1-5% by weight, more preferably 2-4% by weight of barley flour to the dough composition, is found to reduce the stickiness. It is also found to improve the sensorial appreciation.

### Particle Size of the Wheat Flour Composition

The particle size of the wheat flour composition if preferably in the range 50-600 microns.

### The Dough Composition

The dough composition comprises the wheat flour composition and water. The wheat flour composition is preferably 50-70%, more preferably 55-65% and most preferably 56-60% of the dough composition. Water is preferably 30-50. %, more preferably 35-45. % and most preferably 40-44% of the dough composition.

### The Baked Good

The baked good is obtained by the process comprising the steps of:
a. preparing a dough according to the first aspect of the invention,
b. shaping the dough so-obtained in individual pieces of between 20 and 1200 gram, and;
c. baking the so-obtained individual pieces by subjecting them to a baking temperature of between 110 and 400° C.

Preferably a yeast is included in the dough during the step (a). It is further preferred that the process of preparation of the baked good further comprises a leavening step after the step (a) and before the step (c). The yeast is preferably baker's yeast (species: Saccharomyces cerevisiae).

Preferably the step (b) includes rolling of the dough in form of a sheet.

The baked good as obtained at the end of the step (c) is preferably a flat bread. This may include Indian flat breads such as roti, naan and chapatti, but also wheat based tortilla's, pizza and focaccia. The most preferred baked good is chapatti.

The baked good, may further comprise 0.1-5% by weight, more preferably 0.2-4% by weight, still more preferably 0.3-3% by weight, or even 0.5-2% of commonly used seasoning, including salt, pepper, herbs and spices. The baked good may further comprise 1-5% by weight, more preferably 2-4% by weight of edible oil, preferably vegetable oil.

### Non-Baked Foods (a/o Noodles)

Apart from the baked goods defined above, the dough of the present invention is also suitable for making noodles. By a noodles is meant a type of food with a thin and elongated shape made from a dough. The noodles according to the invention may be prepared by extrusion of the dough, or rolling or cutting of thin sheets of dough. After this preparation, the noodles may be dried or fried, or both dried and fried. The noodles may also be shallow fried or deep fried.

Before consumption the noodles are typically be cooked in hot or boiling water or in a mixture of hot or boiling water and oil.

The non-baked good, may further comprise 0.1-5% by weight, more preferably 0.2-4% by weight, still more preferably 0.3-3% by weight, or even 0.5-2% of commonly used seasoning, including salt, pepper, herbs and spices. The non-baked good may further comprise 1-5% by weight, more preferably 2-4% by weight of edible oil, preferably vegetable oil.

### Pasta

The wheat flour composition of the invention may be used in the preparation of a pasta. Pasta is a generic term for noodles made from an unleavened dough of wheat flour and water. The pasta is commercially available in fresh, dried or frozen form.

Pasta typically contains egg, but may also be prepared eggless.

### Eggless Pasta

Eggless pasta typically comprises 65-85% by weight, more preferably 70-85%, still more preferably 75-80% by weight of the wheat flour composition according to the invention. The egg-less pasta further comprising 15-35% by weight of water, preferably, 15-30%, still more preferably 20-25% of water.

### Egg Containing Pasta

The egg-containing pasta composition typically comprises 50-70% by weight, preferably 55-65% by weight of the wheat flour composition of the invention.

The egg containing pasta typically further comprises egg in an amount of 0.5 to 1.5 eggs per 100 g of flour. By egg is meant egg of poultry origin, preferably chicken eggs, but also includes egg replacers as commonly available in the market.

This generally amounts to 25 to 75 g of mixed egg (white and yolk together, or egg replacer) per 100 of flour, and is typically 20% to 40% by weight, more preferably 25-35% by weight of the pasta composition. For getting the best dough rheology, the pasta may further comprise between 2 and 10% by weight, preferably 3 to 8% by weight, even more preferably between 4 and 6% by weight of water.

Thus there is provided for a pasta composition comprising:
50-70% by weight of the wheat flour composition according to the invention
20-40% by weight of egg or egg replacer
2-10% by weight of water

The pasta (egg containing or eggless) may further comprise between 1 and 5% by weight, preferably 2 to 3% by weight of an edible oil, preferably olive oil; and some salt, typically less than 2%, preferably even between 0.5 and 1% by weight.

The invention will now be demonstrated with help of examples. The examples are for the purpose of illustration only and do not limit the scope of the invention in any manner.

### EXAMPLES

The procedure for preparing chapatti is given below:

### Flat Bread (Chapatti) Making Process

Annapurna® (Hindustan Unilever Limited) wheat flour was used in the experiments. The particle size was in the range of 50 to 500 microns with 75% passing through a sieve of 150 microns.

Guar gum was obtained from M/s. Ace gum industries, India with a particle size where 100% gum passed through 250 micron sieve.

Chickpea flour (dehusked) was obtained from Avent Agro Pvt Limited, India.

Mung beans (comparative) were obtained from the market, ground and a flour was obtained with a particle size in the range 50-600 microns and 63% of the mung bean flour passed through 250 microns.

Wheat bran was obtained from a wheat processing mill in Bangalore, India. The particle size of wheat bran was such that 75% of the bran passed through a 150 micron sieve. The wheat flour composition was prepared by mixing all the ingredients. Chapattis were made from the wheat flour compositions using the following protocol

### Step 1. Dough Making

100 grams of the whole wheat flour composition is placed in a plate in form of a heap with a depression at the centre and 60 mL water is added into the depression. The wheat flour composition with the water is kneaded. Additional 15 mL water is added during the kneading to obtain dough. The dough is covered with a dampened cloth for 30 minutes. Dough is formed into four dough balls each weighing 25 grams and the remaining dough is transferred for evaluation.

### Step 2. Rolling of the Chapatti Sheets

The dough ball is dusted with dry wheat flour by rolling in a container filled with dry wheat flour and placed centrally on a circular rolling platform of 10 cm diameter. The dough ball is rolled with a rolling pin to form a roughly circular sheet of about 10 cm diameter and of thickness in the range of 2-3 mm over the entire sheet. Dry wheat flour composition is dusted on the rolling platform or on the surface of the sheet sprinkled during rolling to avoid dough sticking. If the dough is sticky, more dusting with dry wheat flour is done to avoid sticking of the dough to the rolling pin or platform.

### Step 3. Baking.

The baking is placed over a gas flame. When the pan is heated to reach a temperature of 150° C., the sheet is transferred on to the pan. The sheet is baked for 15-20 seconds, flipped and baked further for 15-20 seconds. After baking on both sides, the sheet is directly baked on an open flame for about 2-3 seconds till the sheet puffs completely.

### Evaluation of Chapatti Texture, Dough Rheology and Dough Aroma

Chapatti texture, dough rheology and dough aroma were evaluated by 5 panellists. The scores for each parameter were qualitatively attributed according to the scale given below and final scores are reported as median scores. The qualitative ratings for each of the evaluated parameter are explained below.

### Chapatti Texture

1—same texture as compared to control chapatti made with whole wheat flour—Preferred
2—Slightly rough texture but acceptable
3—Could not be evaluated as chapatti could not be rolled.

### Dough Rheology

1—Softer dough, easier to roll as compared to control chapatti made with whole wheat flour
2—Softer dough, easier to roll, however some dusting is required to roll to avoid stickiness
3—Similar to 2, but more dusting is required, no peripheral breakage of the sheet
4—Similar to 3, but with slight peripheral breakage.
5—Too sticky to roll

### Dough Aroma

1—Beany note masked, mild chicpea note—most preferred
2—Very light beany note, mild chickpea note—preferred
3—Mild beany note, mild chickpea note—acceptable
4—Beany note, mild chickpea note—not acceptable
5—High chickpea note,—not acceptable

### Examples 1-6 and Comparative Examples A-L

Chapattis were made from various wheat flour compositions and various parameters such as dough aroma, dough rheology and chapatti texture were evaluated. The results are tabulated below

TABLE 1
Examples 1-12 and Comparative Examples A-M

| | | Dough | Dough | Chapatti |
|---|---|---|---|---|
| Ex | % WF, %, GG, % CP | Aroma | Rheology | Texture |
| A | 98.5, 1.5, 0 | 4 | 1 | 1 |
| B | 93.5, 1.5, 5 | 4 | 1 | 1 |
| 1 | 91, 1.5, 7.5 | 1 | 2 | 1 |
| 2 | 88.5, 1.5, 10 | 1 | 2 | 1 |
| 3 | 83.5, 1.5, 15 | 1 | 4 | 2 |
| C | 78.5, 1.5, 20 | 5 | 5 | 3 |
| D | 98, 2, 0 | 4 | 1 | 1 |
| E | 93, 2, 5 | 4 | 1 | 1 |
| 4 | 90.5, 2, 7.5 | 3 | 1 | 1 |
| 5 | 88, 2, 10 | 1 | 2 | 2 |
| 6 | 83, 2, 15 | 1 | 3 | 2 |
| F | 78, 2, 20 | 5 | 5 | 3 |
| G | 97.5, 2.5, 2.5 | 4 | 1 | 1 |
| H | 92.5, 2.5, 5 | 4 | 1 | 1 |
| 9 | 90, 2.5, 7.5 | 3 | 1 | 1 |
| 10 | 87.5, 2.5, 10 | 2 | 1 | 1 |
| 11 | 85, 2.5, 12.5 | 1 | 2 | 2 |
| 12 | 82.5, 2.5, 15 | 1 | 2 | 2 |
| I | 77.5, 2.5, 20 | 5 | 3 | 5 |
| J | 85, 5, 10 | 4 | 2 | 1 |
| K | 80, 5, 15 | 4 | 2 | 2 |
| L | 75, 5, 20 | 5 | 5 | 3 |

WF—wheat flour,
GG—guar gum,
C—chickpea (dehusked) flour

From the results, it is clear that the wheat flour compositions within the present invention provide better dough with better rheology without compromising on the dough aroma or chapatti texture.

### Examples 13-15

### Effect of Other Legume Flours and Particle Size of Legume Flour

Chapattis were made from wheat flour compositions similar to that of Example 5 in all respects except with different legume flours. The results are tabulated below.

| | | Dough | Dough | Chapatti |
|---|---|---|---|---|
| Ex | Legume flour (10%) | Aroma | Rheology | Texture |
| 13 | Mung bean flour | 1 | 2 | 2 |
| 14 | Chick pea (with husk) flour retained | | | |
| | on 300 micron sieve | 2 | 2 | 2 |
| 15 | Chick pea (with husk) flour passed | | | |
| | through 300 micron sieve | 1 | 2 | 2 |

The results indicate that legume flours other than chickpea flour can also be used to provide dough with good rheological characteristics without compromising dough aroma or chapatti texture. The results also indicate that the legume flour that passes through 300 micron sieve provides better dough aroma as compared to legume flour that is retained on 300 micron size.

### Effect of Added Wheat Bran

Chapattis were prepared from a wheat flour composition, tabulated below along with the results of evaluation of the organoleptic properties of chapatti and the dough.

| | % WF, % WB %, GG, % | Dough | Dough | Chapatti |
|---|---|---|---|---|
| Ex | CP | Aroma | Rheology | Texture |
| 1 | 83, 5, 2, 10 | 1 | 2 | 2 |

% WB—added wheat bran

From the results it is clear that addition of bran results into good organoleptic properties.

### Examples 16-20 and Comparative Examples M-O

### Addition of Barley Flour for Improved Rheology

Chapattis were made from various wheat flour compositions and various parameters such as dough aroma, dough rheology and chapatti texture were evaluated. The results are tabulated below

TABLE 1
Examples 16-23

| | | Dough | Dough | Chapatti |
|---|---|---|---|---|
| Ex | % WF, %, GG, % CP % BR | Aroma | Rheology | Texture |
| 16 | 86, 2, 12, 0 | 1 | 3 | 2 |
| 17 | 83, 2, 15, 0 | 1 | 3 | 2 |
| M | 80, 2, 18, 0 | 4 | 4 | 2 |
| N | 78, 2, 20, 0 | 5 | 5 | 3 |
| 18 | 83, 2, 12, 3 | 1 | 1 | 1 |
| 19 | 80, 2, 15, 3 | 1 | 2 | 1 |
| O | 77, 2, 18, 3 | 3 | 3 | 2 |
| 20 | 75, 2, 20, 3 | 3 | 4 | 3 |

WF—wheat flour,
GG—guar gum,
C—chickpea (dehusked) flour,
BR—Barley Flour

From the results, it is clear that the wheat flour compositions within the present invention provide better dough with better rheology without compromising on the dough aroma or chapatti texture. The addition of Barley counteracts the negative rheology effects of high legume (chick pea) flour containing compositions.

At higher levels of chickpea, adding Barley further overcomes the strong chickpea notes and thereby improves the sensory properties of the dough and the chapatti.

### Example 17 and Comparative Example P

### Noodle According to the Invention

### Evaluation of Noodle Appearance, Noodle Texture, and Noodle Taste

For the noodle examples, a similar scale as for the chapatti (Indian flat bread) has been used.

The noodle appearance, texture and taste were evaluated by 4 panellists. The scores for each parameter were qualitatively attributed according to the scale given below and final scores are reported as median scores. The qualitative ratings for each of the evaluated parameter are explained below.

### Noodle Appearance

1—Same appearance as compared to control—Preferred
2—Slightly different but acceptable
3—Could not be evaluated as noodles could not be formed (too dark).

### Noodle Texture

1—Same as compared to control made with wheat flour.
2—Similar to control with good noodle texture and bite.
3—Similar to control with slight hardness in bite but acceptable.
4—Slightly harder than control and slightly sticky/slimy.
5—Hard and slimy texture not good and not acceptable.

### Noodle Taste

1—No beany note or chickpea note—most preferred
2—Very light chickpea note, mild chickpea note—preferred
3—Mild beany note, mild chickpea note—acceptable
4—Chickpea note, strong chickpea note—not acceptable
5—V. strong chickpea note,—not acceptable

Noodle were made from various wheat flour compositions and various parameters such as noodle taste, noodle appearance and noodle texture were evaluated. The results are tabulated below

TABLE 1
Example 17 and Comparative Example P

| | | Noodle | Noodle | Noodle |
|---|---|---|---|---|
| Ex | % WF, %, GG, % CP % BR | Taste | Texture | Appearance |
| 17 | 80, 2, 15, 3 | 2 | 2 | 1 |
| P | 100, 0, 0, 0 | 1 | 1 | 1 |

WF—wheat flour,
GG—guar gum,
C—chickpea (dehusked) flour,
BR—Barley Flour

From the results, it is clear that the wheat flour compositions within the present invention provide good noodle with right texture without compromising on the noodle taste or noodle appearance.

### Evaluation of the Data

| Panelist | Noodle Taste | Noodle Texture | Noodle Appearance |
|---|---|---|---|
| Ex 17 | 2 | 2 | 1 |
| Comp P | 1 | 1 | 1 |

Although the chick pea containing noodles have a slightly beany note, they are found to be of good taste to the panelists.

### Examples 18 and 19 and Comparative Example Q

### Pasta According to the Invention

### Preparation

The pasta was prepared by a chef preparing pasta, tasting was done by a panel of 3 (for dough) to 5 (for pasta) people.

### Recipes Pasta

### Example Compositions of Pasta

| Comparative example Q | Example 18 | Example 19 |
|---|---|---|
| 15 g water | 20 g water | 23 g water |
| 250 g Semola flour ^{*)} | 207 g Semola flour ^{*)} | 400 g Semola flour ^{*)} |
| 125 g egg | 125 g egg | 125 g egg |
| (mix of whole eggs) | (mix of whole eggs) | (mix of whole eggs) |
| 10 g olive oil | 10 g olive oil | 10 g olive |
| 3 g salt | 3 g salt | 3 g salt |
| | 37.5 g chick pea | 37.5 g chick pea |
| | 5 g guar gum | 5 g guar gum |
| | | 7.5 g barley flour |

^{*)} Italian wheat

### Evaluation of Pasta Appearance, Pasta Texture, and Pasta Taste

The pasta and dough appearance, texture and taste were evaluated. The scores for each parameter were qualitatively attributed according to the scale given below and final scores are reported as average scores. The qualitative ratings for each of the evaluated parameter are explained below.

### Dough Rheology

1—Soft dough, as compared to control pasta made with hard wheat flour—most preferred
2—Slightly firmer dough, easy to roll—preferred
3—Firmer dough, more difficult to roll, no peripheral breakage of the sheet—acceptable
4—Similar to 3, but with slight peripheral breakage—not acceptable
5—Too sticky to roll—not acceptable

### Dough Aroma

1—Normal aroma, no off flavours—most preferred
2—Very light beany note, mild chickpea note—preferred
3—Mild beany note, mild chickpea note—acceptable
4—Beany note, mild chickpea note—not acceptable
5—Very strong chickpea note—not acceptable

### Pasta Appearance

1—Same appearance as compared to control—Preferred
2—Slightly different but acceptable
3—Could not be evaluated as pastas could not be formed (too dark).

### Pasta Texture

1—Same as compared to control made with wheat flour.
2—Similar to control with good pasta texture and bite.
3—Similar to control with slight hardness in bite but acceptable.
4—Slightly harder than control and slightly sticky/slimy.
5—Hard and slimy texture not good and not acceptable.

### Pasta Taste

1—Normal taste/aroma, no off flavours—most preferred
2—Very light Chickpea note, mild chickpea note—preferred
3—Mild beany note, mild chickpea note—acceptable
4—Chickpea note, strong chickpea note—not acceptable
5—Very strong chickpea note—not acceptable

### Results for Examples 18-19 and Comparative Examples Q

Pasta was made from various wheat flour compositions and various parameters such as pasta taste, pasta appearance and pasta texture were evaluated. The results are tabulated below

### Examples 18-19 and Comparative Examples Q

WF—wheat flour, GG—guar gum, C—chickpea (dehusked) flour, B—barley

### Average Score

| | % WF, %, GG, % CP, | Dough | | | |
|---|---|---|---|---|---|
| Ex | % B | Rheology | Aroma | | |
| 19 | 80, 2, 15, 3 | 2 | 2 | | |
| 18 | 83, 2, 15 | 2 | 2 | | |
| Q | 100, 0, 0, 0 | 1 | 1 | | |
| | Fresh pasta | Before | | | |
| | % WF, %, GG, % CP, | cooking | After cooking | | |
| Ex | % B | Appearance | Appearance | Texture | Taste |
| 19 | 80, 2, 15, 3 | 1 | 1 | 1 | 1 |
| 18 | 83, 2, 15 | 1 | 1 | 1 | 1 |
| Q | 100, 0, 0, 0 | 1 | 1 | 1 | 1 |
| | Frozen pasta | Before | | | |
| | % WF, %, GG, % CP, | cooking | After cooking | | |
| Ex | % B | Appearance | Appearance | Texture | Taste |
| 19 | 80, 2, 15, 3 | 1 | 1 | 1 | 1 |
| 18 | 83, 2, 15 | 1 | 1 | 1 | 1 |
| Q | 100, 0, 0, 0 | 1 | 1 | 1 | 1 |
| | Dried pasta | Before | | | |
| | % WF, %, GG, % CP, | cooking | After cooking | | |
| Ex | % B | Appearance | Appearance | Texture | Taste |
| 19 | 80, 2, 15, 3 | 1 | 1 | 1 | 1 |
| 18 | 83, 2, 15 | 1 | 1 | 1 | 1 |
| Q | 100, 0, 0, 0 | 1 | 1 | 1 | 1 |

The general appreciation of the pasta according to the invention and conventional pasta are at par.

1. A wheat flour composition comprising
a. 40-92.5% wheat flour,
b. 1.5-4.5% guar gum, and;
c. 6-15% chick pea flour.

2. A wheat flour composition as claimed in any one of the preceding claims where the mass ratio of chick pea flour to the guar gum is in the range 1.5 to 10.

3. A wheat flour composition as claimed in any one of the preceding claims comprising 75-91% wheat flour.

4. A wheat flour composition as claimed in any one of the preceding claims comprising 7.5-12% chick pea flour.

5. A wheat flour composition as claimed in any one of the preceding claims characterized in that the particle size of chick pea flour is in the range 50-300 microns.

6. A wheat flour composition as claimed in any one of the preceding claims characterized in that it further comprises 1-5% of barley flour.

7. A dough composition comprising:
a. 50-70% wheat flour composition according to anyone of claims 1 to 6, and;
b. 30-50% water.

8. A baked good obtained by the process comprising the steps of:
a. preparing a dough of claim 7,
b. shaping the dough so-obtained in individual pieces of between 20 and 1200 gram, and;
c. baking the so-obtained individual pieces by subjecting them to a baking temperature of between 110 and 400° C.

9. A baked good according to claim 8 wherein the step (b) includes rolling of the dough in form of a sheet and the baked good obtained at the end of the step (c) is chapatti.

10. A baked good according to claim 8, wherein a yeast is included in the dough in the step (a), and which process further comprises a leavening step after the step (a) and before the step (c).

11. A noodle comprising the dough according to claim 7.

12. A pasta composition comprising:
a. 50-70% by weight of the wheat flour composition according to anyone of claims 1 to 6;
b. 20-40% by weight of egg or egg replacer; and
c. 2-10% by weight of water.

13. A pasta composition comprising:
a. 65-85% by weight of the wheat flour composition according to anyone of claims 1 to 6; and
b. 15-35% by weight of water.
